(19) United States
(12) Patent Application Publication
(10) Pub. No.: US 2011/0116731 A1
(43) Pub. Date: May 19, 2011

(54) CONFINED HEAVY DUTY BUSHING FOR HIGH LOAD APPLICATIONS

(75) Inventor: Ronald J. McLaughlin, Maumee, OH (US)

(73) Assignee: The Pullman Company, Milan, OH (US)

(21) Appl. No.: 12/619,817

(22) Filed: Nov. 17, 2009

(51) Int. Cl. F16C 33/78; B23P 11/00

(52) U.S. Cl. 384/153; 29/428

(57) ABSTRACT

An elastomeric bushing includes an inner component, a pair of outer components and an elastomeric bushing disposed between the inner component and the pair of outer components. An annular gap is defined between the pair of outer components. When the elastomeric bushing is assembled into a housing, the width of the gap is reduced or eliminated increasing the compression of the elastomeric bushing.

### FIELD

The present disclosure relates to an elastomeric bushing assembly which attaches two components together. More particularly, the present disclosure relates to an elastomeric bushing assembly that increases the overall compression of the elastomeric bushing at assembly to better resist both axial and torsional loads.

### BACKGROUND

This section provides background information related to the present disclosure which is not necessarily prior art.

Automotive, truck, bus and other heavy duty applications are commonly designed using an independent front and/or an independent rear suspension system to connect the chassis of the vehicle (the unsprung portion) and the body of the vehicle (the sprung portion). The independent suspension systems normally include an upper control arm, a lower control arm and a hub or knuckle which supports the tire of the vehicle. Each control arm is attached to the frame or other structural component of the vehicle using one or more elastomeric bushing assemblies. Other applications for elastomeric bushing assemblies include, but are not limited to, torque limiting rods, stabilizer bars and other connecting points in the vehicle. The elastomeric bushing assemblies provide joint stabilizer flexibility and isolation from high dynamic load applications.

Each elastomeric bushing assembly typically consists of an outer metal tube that is pressed into a control arm or into one component of the vehicle, an elastomeric bushing disposed within the outer metal and an inner metal which extends through the elastomeric bushing. The inner metal is typically attached to a bracket on a frame or another component of the vehicle. As the vehicle travels, relative movement between the sprung portion and the unsprung portion of the vehicle is accommodated by flexing of a spring such as a coil spring, a torsion bar, an air spring or by some other resilient device. The movement of the sprung portion of the vehicle in relation to the unsprung portion of the vehicle causes rotation, pivoting and/or flexing of the elastomeric bushing assemblies at the connections for the control arms, the stabilizer bars, the torque limiting rods or the other components including elastomeric bushing assemblies.

The isolation provided by the elastomeric bushing assemblies involves complex loadings but the articulation of the elastomeric bushing assemblies is normally resolved into four directions of motion. The four directions of motion include radial motion, axial motion, torsional motion and conical motion. Typically, an elastomeric bushing is designed such that the major loading acts in the radial direction.

The continued development of elastomeric bushing assemblies is directed toward improving their load resistance capabilities while simplifying construction, reducing costs and improving the durability of the elastomeric bushing assemblies.

### SUMMARY

This section provides a general summary of the disclosure, and is not a comprehensive disclosure of its full scope or all of its features.

The present disclosure provides the art with an elastomeric bushing assembly having a pair of cup-shaped outer metals which define a gap between them prior to the installation of the elastomeric bushing assembly into a suitable recess located in its respective articulated component. The elastomeric bushing is bonded to both of the outer metal cups. During the assembly of the elastomeric bushing assembly into the suitable recess, the gap between the two cups is reduced or eliminated and the two cup-shaped outer metals approach each other or contact each other. The elastomeric bushing is further compressed when the gap is reduced or eliminated. The further compression of the elastomeric bushing relieves localized elastomer stresses and builds the overall compression that resists axial, radial, torsional and conical loads.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a typical suspension system for a vehicle which incorporates elastomeric bushing assemblies in accordance with the present disclosure;

FIG. 2 is a perspective view of an elastomeric bushing assembly in accordance with the present disclosure;

FIG. 3 is a cross-sectional view of the elastomeric bushing assembly illustrated in FIGS. 1 and 2;

FIG. 4 is a perspective view of the outer metal illustrated in FIGS. 1 and 2;

FIG. 5 is a cross-sectional view of the elastomeric bushing assembly illustrated in FIGS. 1 and 2 assembled into a housing; and

FIG. 6 is a cross-sectional view of the elastomeric bushing assembly illustrated in FIGS. 1 and 2 assembled into a housing in accordance with another embodiment of the present disclosure.

Corresponding reference numerals indicate corresponding parts throughout the several views of the drawings.

### DETAILED DESCRIPTION

Example embodiments will now be described more fully with reference to the accompanying drawings.

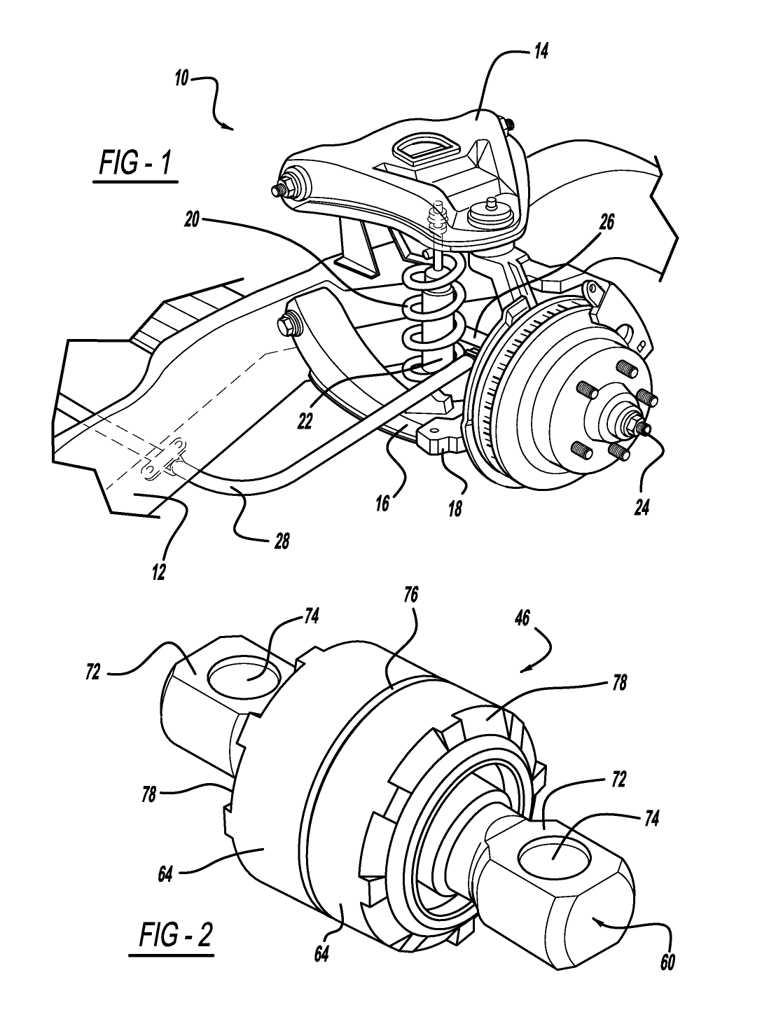

Referring now to the drawings in which like reference numerals designate like or corresponding parts throughout the several views, there is illustrated in FIG. 1, a truck, bus or highly loaded suspension system incorporating the elastomeric bushing assembly in accordance with the present disclosure and which is designated generally by reference numeral 10. Suspension system 10 comprises a frame or supporting structure of the supporting structure 12, an upper control arm 14, a lower control arm 16, a hub or knuckle 18, a coil spring 20, a shock absorber 22 and a drive axle assembly 24. Frame or supporting structure 12 supports a body (not shown) and other components of the vehicle which are generally identified as the “sprung mass”. Drive axle assembly 24 is attached to a differential or a transaxle (not shown) which receives torque from an engine (not show). Drive axle assembly 24 includes a pair of constant or non-constant velocity joints (not shown). One joint is attached to the differential and one joint is attached to hub or knuckle 18. A drive shaft 26 extends between the two joints. The engine transmits rotation and torque to the differential or transaxle which transfers the rotation and torque from the engine to hub or knuckle 18 through drive axle assembly 24. A wheel (not shown) attached to hub or knuckle 18 is driven by drive axle assembly 34 through hub or knuckle 18. The constant or non-constant velocity joints permit the transmission of torque at various angles which allows suspension system 10 to undergo jounce and rebound motions while still transmit torque from the differential or transaxle to the wheel of the vehicle.

Coil spring 20 supports the load for the sprung portion of the vehicle and shock absorber 22 dampens the movement of the wheel with respect to frame or supporting structure 12 as is well known in the art. A torque rod or anti-roll bar 28 can be disposed between frame or supporting structure 12 and hub or knuckle 18 to assist in the control of the wheel with respect to frame or supporting structure 12 as is well known in the art.

Referring now to FIGS. 1, 2 and 3, upper control arm 14 and lower control arm 16 are each attached to frame or supporting structure 12 using a pair of elastomeric bushing assemblies 46. Each elastomeric bushing assembly 46 is disposed between control arms 14 and 16 and frame or supporting structure 12 to accommodate the motion between these two components and to isolate the sprung portion of the vehicle from shock.

While the present disclosure is being illustrated as having two elastomeric bushing assemblies 46 disposed between upper control arm 14 and 16 and frame or supporting structure 12 and one elastomeric bushing assembly 46 disposed between lower control arm 16 and frame or supporting structure 12, it is within the scope of the present disclosure to utilize elastomeric bushing assembly 46 between any two components that require one of the components to pivot with respect to the other component. In addition, while the present disclosure is being described as having three identical elastomeric bushing assemblies 46 disposed between control arms 14 and 16 and frame or supporting structure 12, it is within the scope of the present disclosure to utilize a different design for each elastomeric bushing assembly 46. Also, while the present disclosure is being illustrated in conjunction with an independent suspension system, it is within the scope of the present disclosure to utilize elastomeric bushing assembly 46 in other suspension designs including, but not limited to, leaf spring suspension systems.

Referring now to FIGS. 2-4, elastomeric bushing assembly 46 comprises an inner component 60, an elastomeric bushing 62 and a pair of outer components 64. While elastomeric bushing assembly 46 is illustrated using two identical outer components 64, it is within the scope of the present disclosure to utilize two different outer components 64.

Inner component 60 is illustrated as a metal bar pin which includes a generally cylindrical center section 70 and a pair of generally rectangular sections 72, one generally rectangular section 72 being disposed at opposite ends of cylindrical center section 70. While inner component 60 is illustrated as a metal component, it is within the scope of the present disclosure to use other materials for inner component 60. Each generally rectangular section 72 has an aperture 74 extending through it which is used to secure elastomeric bushing assembly 46 to the appropriate bracket. While inner component 60 is illustrated as a bar pin having a generally cylindrical center section 70, it is within the scope of the present disclosure to have different inner components including, but not limited to, a cylindrical bar, a tubular bar or any other inner component known in the art. If a tubular inner component is used, typically a through bolt extending through the inner component is used to secure the elastomeric bushing assembly to the vehicle.

Elastomeric bushing 62 is an elastomeric annular member which is located between inner component 60 and outer components 64. The uncompressed wall thickness of annular elastomeric bushing 62 is larger than the space between inner component 60 and outer components 64 such that a specified percent compression is applied to elastomeric bushing 62 when it is assembled into elastomeric bushing assembly 46. The assembly of elastomeric bushing 62 is accomplished by first bonding elastomeric bushing 62 to outer components 64 and then inserting inner component 60 into elastomeric bushing 62. The compression of elastomeric bushing 62 provides the specified percent compression of elastomeric bushing 62 and inner component 60 is bonded to elastomeric bushing 62 during assembly in order to resist relative motion between the two components. While the present disclosure illustrates a bond between elastomeric bushing 62 and inner component 60, it is within the scope of the present disclosure to provide a mechanical bond due to the compression of elastomeric bushing 62 between elastomeric bushing 62 and inner component 60.

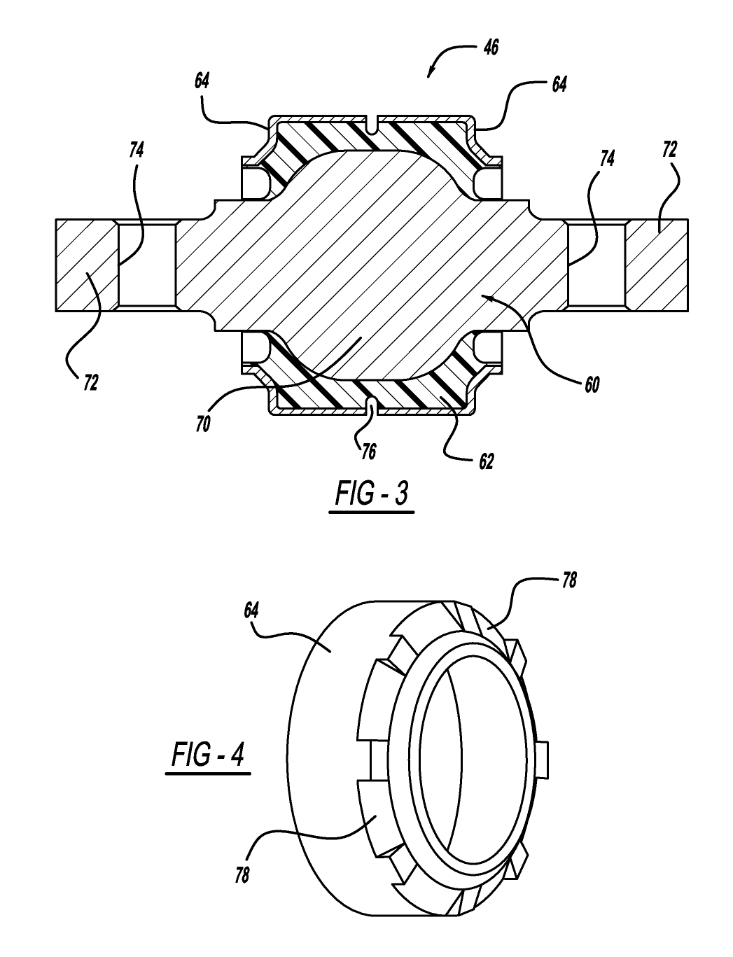

Outer components 64 are each a cup-shaped component which is illustrated as a metal cup-shaped component. While outer components 64 are illustrated as metal components, it is within the scope of the present disclosure to use other materials for outer components 64. As illustrated in FIGS. 2 and 3, an annular gap 76 having a specified or first width exists between outer components 64 when elastomeric bushing assembly 46 is assembled. Gap 76 exists prior to elastomeric bushing assembly 46 is assembled into the appropriate housing as discussed below. Each outer component 64 defines a plurality of indentations 78 which are utilized to control the dimensional accuracy for outer component 64.

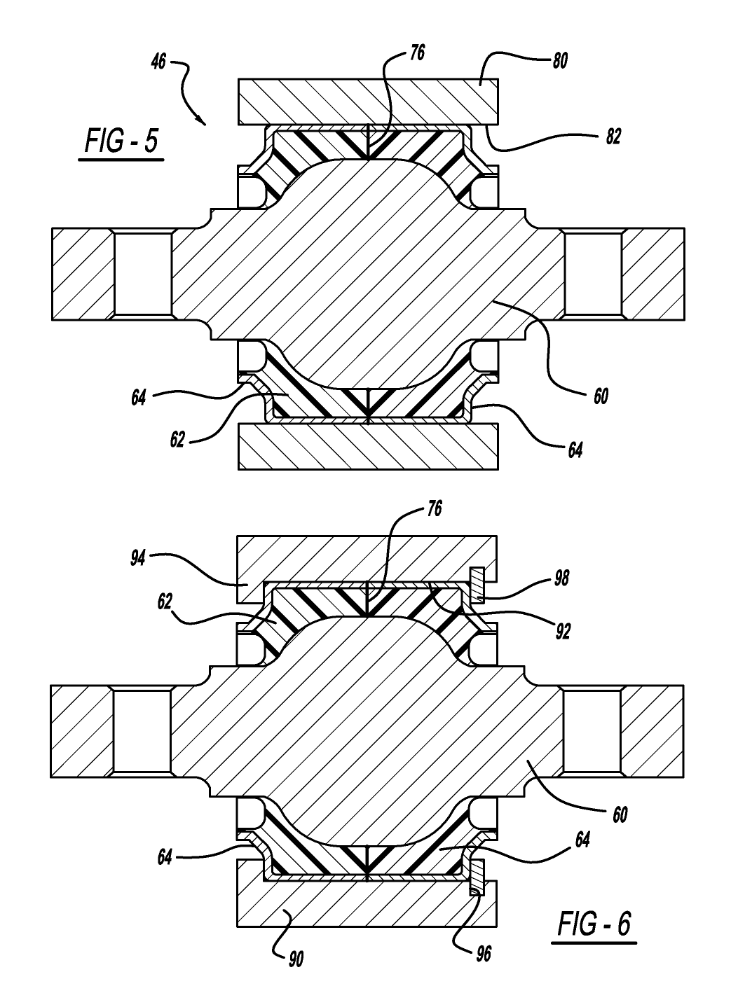

Referring now to FIG. 5, elastomeric bushing assembly 46 is illustrated assembled into a housing 80 to form a bushing assembly. Housing 80 defines a cylindrical bore 82 within which elastomeric bushing assembly 46 is press fit. The press fitting of elastomeric bushing assembly 46 into bore 82 reduces or eliminates gap 76 such that gap 76 has a second width, smaller than the first width when assembled to housing 80. The elimination of gap 76 further compresses elastomeric bushing 62. The further compressing of elastomeric bushing 62 relieves localized elastomer stresses in elastomeric bushing 62 and builds the overall compression for elastomeric bushing 62 which resists both axial and torsional loadings.

Referring now to FIG. 6, elastomeric bushing assembly 46 is illustrated assembled into a housing 90 to form a bushing assembly. Housing 90 defines a cylindrical bore 92 having a flange 94 defined at one end and a groove 96 defined at the opposite end. Elastomeric bushing assembly 46 is press fit within bore 92 such that it engages flange 94. The opposite end of elastomeric bushing assembly 46 is pressed beyond groove 96 and a snap ring 98 is assembled into groove 96 to retain elastomeric bushing assembly 46. The assembly of elastomeric bushing assembly 46 into bore 92 reduces or eliminates gap 76 such that gap 76 has a second width smaller than the first width when assembled to housing 90. The elimination of gap 76 further compresses elastomeric bushing 62. The further compressing of elastomeric bushing 62 relieves localized elastomer stresses in elastomeric bushing 62 and builds the overall compression for elastomeric bushing 62 which resists both axial and torsional loadings.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A bushing assembly comprising:
an inner component;
a first outer component disposed over said inner component;
a second outer component disposed over said inner component, a gap having a first width being defined between said first and second outer components; and
an elastomeric bushing disposed between said inner component and said first and second outer components.

2. The bushing assembly according to claim 1, wherein said elastomeric bushing is bonded to said first and second outer components.

3. The bushing assembly according to claim 2, wherein said elastomeric bushing is bonded to said inner component.

4. The bushing assembly according to claim 1, further comprising:
a housing disposed around said first and second outer components, said gap having a second width smaller than said first width when said housing is disposed over said first and second outer components.

5. The bushing assembly according to claim 4, wherein said housing defines a cylindrical bore within which said first and second outer components are press fit.

6. The bushing assembly according to claim 4, wherein said housing defines a stepped cylindrical bore within which said first and second outer components are press fit.

7. The bushing assembly according to claim 6, further comprising a snap ring disposed within a groove defined by said housing.

8. A method of assembling a bushing assembly, the method comprising:
providing an inner component;
providing a first outer component over said inner component;
providing a second outer component over said inner component;
defining a gap between said first outer component and said second outer component;
providing an elastomeric bushing between said inner component and said first and second outer components;
providing a housing defining a bore;
assembling said first and second outer components into said bore defined by said housing;
reducing a width of said gap during said assembling step.

9. The method according to claim 8, wherein the step of providing said elastomeric bushing includes bonding said elastomeric bushing to said first and second outer components.

10. The method according to claim 9, wherein the step of providing said elastomeric bushing includes bonding said elastomeric bushing to said inner component.

11. The method according to claim 8, wherein the step of providing said elastomeric bushing includes bonding said elastomeric bushing to said inner component.

12. The method according to claim 8, wherein the step of providing said housing defining said bore includes providing said housing defining a cylindrical bore.

13. The method according to claim 8, wherein the step of providing said housing defining said bore includes providing said housing defining a stepped cylindrical bore.

14. The method according to claim 13, further comprising assembling a snap ring into a groove defined by said housing.

15. The method according to claim 8, wherein the reducing step includes increasing the compression of said elastomeric bushing.

16. A bushing assembly comprising:
an inner component;
a first outer component disposed over said inner component;
a second outer component disposed over said inner component, a gap being defined between said first and second outer components;
an elastomeric bushing disposed between said inner component and said first and second outer components; and
a housing disposed around said first and second outer components.

17. A bushing assembly according to claim 16, wherein said gap is an annular gap.

18. The bushing assembly according to claim 16, wherein said elastomeric bushing is bonded to said first and second outer components.

19. The bushing assembly according to claim 18, wherein said elastomeric bushing is bonded to said inner component.

20. The bushing assembly according to claim 16, wherein said housing defines a cylindrical bore within which said first and second outer components are press fit.

21. The bushing assembly according to claim 16, wherein said housing defines a stepped cylindrical bore within which said first and second outer components are press fit.

22. The bushing assembly according to claim 21, further comprising a snap ring disposed within a groove defined by said housing.
